(19) United States
(12) Patent Application Publication
(10) Pub. No.: US 2003/0213688 A1
(43) Pub. Date: Nov. 20, 2003

(54) Process control of a distillation column

(76) Inventors: Baechen Benson Wang, Livingston, NJ (US); Mark D. Alexion, Parsippany, NJ (US)

Correspondence Address: Wan Yee Cheung, Intellectual Property Dept., The BOC Group, Inc., 100 Mountain Ave., Murray Hill, NJ, 07974, US

(21) Appl. No.: 10/107,015

(22) Filed: Mar. 26, 2002

(51) Int. Cl. B01D 3/00; B01D 3/42

(52) U.S. Cl. 203/1; 203/2; 202/160

(57) ABSTRACT

A method and apparatus for process control in a distillation column are disclosed. The method allows undesirable interactions among control parameters to be minimized, and results in improved process control and operational stability. Process control of a liquid assisted nitrogen generator using the improved method is disclosed as an illustrative example.

### FIELD OF THE INVENTION

The present invention relates generally to a method and apparatus of process control, and more particularly, to process control of a distillation column.

### BACKGROUND OF THE INVENTION

In a typical distillation process, mixtures are distilled and separated into different components by contacting liquid and vapor phases of the mixture on liquid-vapor contact elements contained within a distillation column. The liquid-vapor contact elements can be trays, random packing or structured packing. In an air separation process using cryogenic distillation, a feed air stream is first compressed to a high pressure and pre-purified to reduce water, hydrocarbons and carbon dioxide to acceptable levels. The compressed, pre-purified air stream is then cooled to cryogenic temperature by heat exchange with product and waste streams exiting the distillation column. The cooled air stream is introduced to the bottom of the distillation column where rectification takes place. As vapor rises through liquid-vapor contact elements in the distillation column, it becomes increasingly more concentrated in nitrogen. On the other hand, the liquid phase becomes increasingly more concentrated in oxygen as it descends and accumulates as an oxygen-rich liquid at the bottom of the distillation column.

The operation of an air separation unit requires the control of three main attributes mass balance, thermal balance and purity. Mass balance is usually controlled by controlling the column pressure, thermal balance is usually maintained by controlling the liquid level inside the column, while product purity is changed by varying the liquid to vapor ratio in the column. In conventional methods of process control, a control measure for one parameter often affects another control parameter, resulting in undesirable variations in overall process stability. Thus, there is an ongoing need for alternative methods of process control with improved process stability.

### SUMMARY OF THE INVENTION

The present invention provides generally a method and apparatus for process control in a distillation column. According to one aspect of the invention, the method involves the introduction of a feed gas stream to a first inlet of the column and a liquid stream flow into a second inlet located above the first inlet. A liquid indicating controller is used to monitor and control the liquid level inside the column, and a pressure indicating controller is used to monitor and control the column pressure. The purity of a gas product, which is withdrawn from a gas outlet from the top of the column, is controlled at a desired purity level by regulating the liquid stream flow into the column using a liquid flow controller.

In one embodiment of the invention, a compressed feed air stream is introduced to a first inlet of the column and a liquid nitrogen stream flow is introduced into a second inlet located above the first inlet. A liquid sensor monitors the liquid level inside the column and provides a liquid level signal to a liquid indicating controller. Based on the liquid level signal, the liquid indicating controller controls a valve to regulate an oxygen-enriched liquid stream flow out of a bottom outlet of the column. The pressure in the column is monitored by a pressure sensor, which provides a pressure signal to a pressure indicating controller. Based on the pressure signal, a product gas flow in a product gas conduit and a vent gas flow in a vent gas conduit are regulated by the pressure indicating controller. The purity of a nitrogen-enriched gas product, which is withdrawn from a gas outlet at the top of the column, is controlled at a desired purity level by regulating the liquid nitrogen stream flow into the column using a flow indicating controller in conjunction with an analyzer indicating controller, in which the analyzer indicating controller sends a purity-indicating signal to the flow indicating controller, and the liquid nitrogen stream flow is regulated by the flow indicating controller based on the purity-indicating signal.

According to another aspect of the invention, an apparatus comprises a distillation column having a feed gas inlet, a liquid inlet located above the feed gas inlet, a liquid outlet at the bottom of the column and a gas outlet at a top of the column. The apparatus further contains a liquid level indicating controller for monitoring and controlling a liquid level inside the distillation column, a pressure indicating controller for monitoring and controlling the column pressure, a liquid source connected to the liquid inlet, a flow indicating controller for monitoring and controlling a liquid flow from the liquid source to the liquid inlet, and an analyzer indicating controller connected at one end to a gas analyzer for monitoring a purity level of a gas product withdrawn from the gas outlet; and the analyzer indicating controller is further connected at another end to the flow indicating controller for adjusting a liquid flow set point for the flow indicating controller.

### BRIEF DESCRIPTION OF THE DRAWINGS

While the specification concludes with claims distinctly pointing out the subject matter that the applicants regard as their invention, it is believed the invention would be better understood when taken in connection with the accompanying drawings in which:

FIG. 1 is a schematic diagram illustrating a method of process control according to the present invention.

### DETAILED DESCRIPTION

The present invention relates to a method and apparatus of process control for use in a distillation column. More particularly, the method is illustrated in an example of process control in a nitrogen generating plant or nitrogen generator.

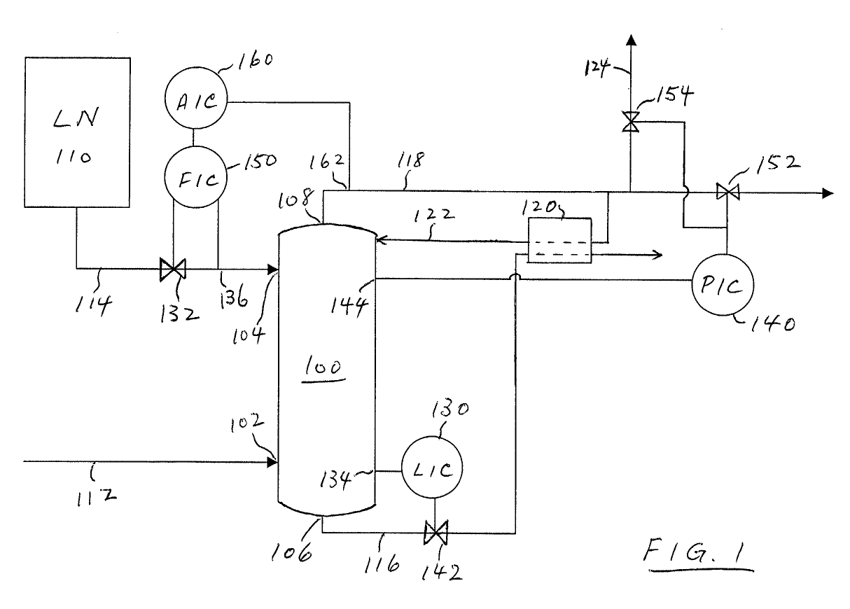

FIG. 1 is a schematic diagram showing a method of process control according to the present invention as applied to a cryogenic air separation plant for nitrogen generation. For clarity's sake, many components such as heat exchangers, valves, expanders and so forth that may typically be found in a nitrogen generator have been omitted. The nitrogen generator comprises a distillation column 100 having a gas inlet 102, a liquid inlet 104, a liquid outlet 106, and a gas outlet 108. A feed air stream in conduit 112 has been pre-purified, compressed and cooled to a cryogenic temperature suitable for rectification. Such pre-purification, compression and cooling are performed using techniques that are known in the art. The feed air stream, which is introduced at a constant flow rate to a bottom portion of the distillation column 100 via the gas inlet 102, is subjected to rectification and separates into two components—a nitrogen-enriched vapor and an oxygen-enriched liquid.

The nitrogen generating plant of FIG. 1 uses a liquid injection scheme in which a liquid nitrogen stream from a liquid nitrogen (LN) source 110 is introduced to a top portion of the distillation column 100 via a conduit 114 and the liquid inlet 104. The addition of the liquid nitrogen stream provides sufficient refrigeration such that the distillation process can be run without the use of an expander that would otherwise be required.

A gas product stream (nitrogen-enriched vapor) is withdrawn via the gas outlet 108 at the top of the column 100. The oxygen-rich liquid at the bottom of the column 100 is withdrawn from the outlet 106 as a liquid stream which passes along a conduit 116 into a condenser 120. The oxygen-rich liquid stream exchanges heat with a portion of the gas product stream inside the condenser 120, resulting in vaporization of the oxygen-rich liquid and condensation of the portion of the gas product stream. The vaporized oxygen-rich stream may then be used to cool incoming feed air stream in a heat exchanger (not shown) before exiting the nitrogen generator.

During operation of the nitrogen generator, several parameters are monitored and controlled in order to maintain desired operating conditions and process performance. These parameters include the liquid level and pressure inside the column 100, as well as the product gas purity. Process control of the distillation column 100 is accomplished by the use of four controllers—a liquid indicating controller (LIC) 130, a pressure indicating controller (PIC) 140, a flow indicating controller (FIC) 150, and an analyzer indicating controller (AIC) 160.

Using a conventional process control scheme, these controllers are connected to the nitrogen generator in a different manner compared to that shown in FIG. 1. Due to the interactions or coupling among different control measures as implemented by the conventional scheme, the control of one process parameter often directly affects another process parameter. For example, an attempt to control product purity may lead to variations in the column pressure, which in turn affects the liquid level control during distillation. Such parameter interactions in the control scheme often result in undesirable instabilities in the operation of the distillation column.

The method of process control shown in FIG. 1 seeks to minimize the interaction of these control parameters. Liquid level, pressure and product purity are controlled in a way that they are substantially decoupled from each other, so that an attempt at controlling one parameter will not result in undesirable effects on another parameter.

For example, the LIC 130 in FIG. 1 is connected to a liquid level sensor 134 for monitoring the liquid level at an appropriate location in the column 100. The LIC 130 is further connected to a valve 142 located in the conduit 116 leading from the outlet 106. Based on a signal received from the sensor 134 relating to the liquid level, the LIC 130 sends an output signal to the valve 142 in order to maintain the liquid level at a desired operating level by appropriate control of the flow of liquid stream out of the bottom of the column 100. Thus, depending on whether the liquid level falls below or exceeds a desired level, the valve 142 will be adjusted to reduce or increase the liquid stream withdrawn from the outlet 106. Although such liquid level control may still affect the purity of the gas product (i.e., by changing the liquid to vapor flow ratio), the purity will be compensated by the liquid reflux flow that is controlled by the AIC 160 and the FIC 150, which will be discussed below. Under this control scheme, the interaction between product purity and other parameters is reduced compared to the conventional control scheme.

The PIC 140 is connected to the pressure sensor 144 to receive a signal relating to the pressure in the column 100. Although the pressure sensor 144 is often located at the top or overhead region of the column 100, it can also be positioned at other locations appropriate for pressure measurements. Based on the pressure information, the PIC 140 controls valves 152 and 154 in the gas product conduit 118 and the vent conduit 124 accordingly. For example, if the column pressure is too high compared to a desired operating level, then valve 152 and/or valve 154 is opened to increase the flow of gas product out of the column 100. Depending on the customer's demand, the flow valve 152 may be set to produce a gas flow rate up to the capacity of the nitrogen generator, while the vent valve 154 is adjusted to allow a portion of the gas product to be vented via the conduit 124 in order to achieve the desired operating column pressure. Pressure control according to this method can be more rapidly achieved than previously attainable.

Since a distillation column is designed to operate at a certain pressure, the process control method of this invention seeks to directly control the column pressure, e.g., using the PIC 140 as shown in FIG. 1. With the column pressure fixed at a desired level, other parameters can be adjusted and controlled relatively independently of each other. This represents an improvement over the conventional control scheme, in which column pressure is only indirectly controlled, and the effect of one control factor or parameter tends to propagate to another control factor in the cycle.

Different settings of the valves 152 and 154 may be used in conjunction with the PIC 140 for controlling the column pressure. In one configuration, for example, the valve 152 is set at a fully open position, allowing a maximum product flow rate to the customer site. If customer's demand for the product gas exceeds plant capacity, the pressure in the column 100 may decrease below a desired operating pressure set point. The PIC 140 then closes the vent valve 154 in order to maintain the distillation column 100 within the desired operating pressure range. If this proves insufficient, then valve 152 may be adjusted to help control the column pressure. On the other hand, if customer's demand for the product gas is less than plant capacity, the column pressure may increase above a desired operating pressure set point. The PIC 140 then sends a signal to open the vent valve 154 in order to maintain the distillation column 100 at the desired operating pressure range.

In another configuration, the valve 154 may be set initially at a partially open position. Depending on the customer's demand, the PIC 140 sends appropriate signals to adjust one or both of the valves 152 and 154 in order to maintain the column pressure within a desired operating range. In general, different combinations of settings may be used for valves 152 and 154 to provide the necessary product flow and pressure control in the column 100.

Under the process control scheme of FIG. 1, the gas product purity is controlled solely by regulating the liquid nitrogen flow from the liquid nitrogen source 110 into the distillation column 100. The FIC 150 and the AIC 160 are used in conjunction with each other in a cascade fashion, in which the AIC 160 is the primary controller and the FIC 150 is a secondary controller. In this case, the AIC 160 sets a liquid flow set point for the FIC 150 according to the purity of the gas product from the distillation column 100. As shown in FIG. 1, the AIC 160 is connected to the gas analyzer 162 that is used to monitor the product gas purity by sampling the product gas stream in the product gas conduit 118. It is understood that the gas sampling point for the gas analyzer 162 may be located at various positions that are convenient or appropriate for product gas purity measurement.

Based on the product gas purity, the AIC 160 sends an output signal to the FIC 150 to adjust a set point for the liquid nitrogen flowing through the conduit 114 into the column 100. The FIC 150 is connected at one end to a liquid flow sensor 136 and at the other end to a liquid flow valve 132. Both the liquid flow sensor 136 and the liquid flow valve 132 are installed along the conduit 114. Based on the liquid flow set point (as determined by the AIC 160) and the liquid flow measurement by the sensor 136, the FIC 150 in turn sends an output signal to the valve 132 for regulating the liquid flow accordingly.

For example, if the gas product purity falls below a desired purity level (i.e., too much impurities in the product), then the liquid flow set point will be adjusted to provide an increased liquid flow into the column 100. The increased liquid flow will result in an increase of the liquid to vapor flow ratio inside the column 100, thus increasing the purity of the gas product. Using this control scheme, rapid liquid flow control can be readily accomplished, which in turn results in a fast response for gas purity control. In an alternative embodiment, the flow sensor 136 may be omitted, and the FIC 150 is configured to send a signal to adjust valve 132 according to a liquid flow set point determined by the AIC 160.

The process control method of the present invention provides several advantages over the conventional method. For example, by decoupling the control of liquid level, pressure and product purity from each other, a more stable operation of the distillation process may be achieved. The relatively fast response for gas purity control provided by the regulation of liquid stream flow into the column provides a method that is more responsive to customer's demands. Furthermore, since the product flow control as implemented by the pressure indicating controller is decoupled from the product gas purity, product gas flow to the customer can be supplied at any flow rate up to the plant capacity at desired purity, without being restricted unnecessarily by conditions dictated by gas purity, as may occur in conventional control schemes.

While the present invention has been described with reference to several embodiments, as will occur to those skilled in the art, numerous changes, additions and omissions may be made without departing from the spirit and scope of the present invention.

We claim:

1. A method of process control in a distillation column, comprising:
(a) introducing a feed gas stream to a first inlet of said column;
(b) providing a liquid stream flow into a second inlet located above said first inlet of said column;
(c) controlling a liquid level inside said column using a liquid indicating controller;
(d) controlling a pressure in said column using a pressure indicating controller;
(e) withdrawing a gas product from a gas outlet at a top portion of said column; and
(f) controlling said gas product at a desired purity level by regulating said liquid stream flow into said column using a liquid flow controller.

2. The method of claim 1, wherein said controlling of said gas product purity in (f) comprises:
connecting an analyzer indicating controller to said liquid flow controller;
monitoring a product gas purity using a gas analyzer connected to said analyzer indicating controller;
providing a first signal from said analyzer indicating controller to said liquid flow controller, said first signal being responsive to said product gas purity; and
generating a second signal from said liquid flow controller to a liquid flow valve connected to said second inlet to regulate said liquid stream flow into said column; wherein said second signal is responsive to said first signal.

3. The method of claim 2, further comprises connecting said liquid flow controller to a liquid flow sensor for monitoring a flow rate of said liquid stream flow into said second inlet, said first signal being used to set a liquid flow set point for said liquid flow controller, and said second signal adjusts said liquid flow valve to regulate said liquid stream flow in accordance with said liquid flow set point.

4. The method of claim 2, wherein said controlling of said liquid level in (c) comprises:
connecting one end of said liquid indicating controller to a liquid level sensor and another end of said liquid indicating controller to a valve connected to a bottom outlet of said column;
monitoring said liquid level inside said column using said liquid level sensor;
providing a third signal from said liquid indicating controller to said valve to regulate a liquid stream flow out of said bottom outlet of said column; wherein said third signal is responsive to said liquid level monitored by said liquid level sensor.

5. The method of claim 2, wherein said controlling of said pressure in (d) comprises:
connecting one end of said pressure indicating controller to a pressure sensor for measuring said pressure of said column and another end of said pressure indicating controller to a first gas valve in a product gas conduit and a second gas valve in a gas vent conduit;
controlling said column pressure by sending a fourth signal from said pressure indicating controller to said first gas valve and a fifth signal from said pressure indicating controller to said second gas valve; wherein said fourth and fifth signals are responsive to said column pressure.

6. The method of claim 1, wherein said feed gas stream is a compressed air stream, said liquid stream flow into said second inlet comprises liquid nitrogen, and said gas product comprises a nitrogen-enriched vapor.

7. A method of process control in a distillation column, comprising:
(a) introducing a compressed feed air stream to a first inlet of said column;
(b) providing a liquid nitrogen stream flow into a second inlet located above said first inlet of said column;
(c) monitoring a liquid level inside said column using a liquid sensor and providing a liquid level signal from said liquid sensor to a liquid indicating controller; wherein said liquid indicating controller controls a valve to regulate an oxygen-enriched liquid stream flow out of a bottom outlet of said column based on said liquid level signal;
(d) monitoring a pressure in said column using a pressure sensor and providing a pressure signal from said pressure sensor to a pressure indicating controller; wherein said pressure indicating controller regulates a product gas flow in a product gas conduit and a vent gas flow in a vent gas conduit based on said pressure signal;
(e) withdrawing a nitrogen-enriched gas product from a gas outlet at a top portion of said column;
(f) controlling said nitrogen-enriched gas product at a desired purity level by regulating said liquid nitrogen stream flow into said column using a flow indicating controller in conjunction with an analyzer indicating controller; wherein said analyzer indicating controller sends a purity-indicating signal to said flow indicating controller, and said flow indicating controller regulates said liquid nitrogen stream flow based on said purity-indicating signal.

8. An apparatus for producing a gas product, comprising:
a distillation column having a feed gas inlet, a liquid inlet located above said feed gas inlet, a liquid outlet at a bottom of said column and a gas outlet at a top of said column;
a liquid level indicating controller (LIC) for monitoring and controlling a liquid level inside said distillation column;
a pressure indicating controller (PIC) for monitoring and controlling pressure inside said distillation column;
a liquid source connected to said liquid inlet;
a flow indicating controller (FIC) for monitoring and controlling a liquid flow from said liquid source to said liquid inlet; and
an analyzer indicating controller (AIC) connected at one end to a gas analyzer for monitoring a purity level of a gas product withdrawn from said gas outlet; said AIC further connected at another end to said FIC for adjusting a liquid flow set point for said FIC.

9. The apparatus of claim 8, wherein said purity level of said gas product is controlled by controlling said liquid flow from said liquid source to said liquid inlet based on said liquid flow set point.

10. The apparatus of claim 9, wherein said LIC is connected at one end to a liquid sensor for monitoring said liquid level inside said column and connected at another end to a valve for regulating a liquid flow out of said liquid outlet based on said liquid level.

11. The apparatus of claim 10, wherein said PIC is connected to a pressure sensor for monitoring said pressure inside said column and further connected to a first valve for regulating a portion of a product gas flow from said gas outlet and to a second valve for regulating another portion of said product gas flow in a vent conduit.

12. The apparatus of claim 11, wherein said liquid source is a liquid nitrogen source, and said gas product is a nitrogen-enriched vapor.
